(19) United States
(12) Patent Application Publication
(10) Pub. No.: US 2025/0350074 A1
(43) Pub. Date: Nov. 13, 2025

(54) CONNECTOR

(71) Applicant: Yazaki Corporation, Tokyo (JP)

(72) Inventors: Atsunori IWASHITA, Shizuoka (JP); Masayuki ISHIGAMI, Shizuoka (JP)

(73) Assignee: Yazaki Corporation, Tokyo (JP)

(21) Appl. No.: 19/191,044

(22) Filed: Apr. 28, 2025

(30) Foreign Application Priority Data
May 7, 2024 (JP) 2024-075073

(51) Int. Cl. H01R 13/70; H01R 13/512

(52) U.S. Cl. CPC H01R 13/701; H01R 13/512

(57) ABSTRACT

A connector includes: a housing; a first conductive member housed in the housing; a second conductive member that is housed in the housing and is electrically connected to the first conductive member by fastening a fastening member; a cover that is assembled so as to close an opening of the housing where the fastening member is exposed; and an interlock terminal that is housed in the housing and is connectable and is disconnectable a conduction state between the first conductive member and the second conductive member. In the connector, the cover includes a connecting portion that is electrically connected to the interlock terminal and causes the first conductive member and the second conductive member to be in a conduction state, when the cover is assembled to the housing.

### CROSS REFERENCE TO RELATED APPLICATION

The present application is based on, and claims priority from the prior Japanese Patent Application No. 2024-075073, filed on May 7, 2024, the entire contents of which are incorporated herein by reference.

### TECHNICAL FIELD

The present disclosure relates to a connector.

### BACKGROUND

Conventionally, a connector includes a housing, a device side terminal as a first conductive member which is housed in the housing, and an electric wire side terminal as a second conductive member which is housed in the housing and is electrically connected to the device side terminal by fastening a fastening member. Further, the connector having a cover that is assembled so as to close an opening of the housing where the fastening member is exposed is also known (JP 2016-213048 A).

In the connector, the electric wire side terminal constitutes a waiting side connector mounted in the housing. The waiting side connector can be fitted with a movable side connector. The housing and the waiting side connector house a bus bar and a relay terminal, respectively as an interlock terminal that can be connectable and be disconnectable a conduction state between the device side terminal and the electric wire side terminal. The movable side connector has a short pin as a connecting portion which is electrically connected to the relay terminal and causes the device side terminal and the electric wire side terminal to be in a conduction state, when the movable side connector is fitted with the waiting side connector.

In this kind of connector, when the device side terminal and the electric wire side terminal are electrically disconnected by maintenance or the like, first the waiting side connector and the movable side connector are unfitted, for example. At this time, the relay terminal and the short pin are electrically disconnected, the device side terminal and the electric wire side terminal are in a non-conduction state, and accordingly it is possible to prevent electric shock of an operator, for example. Then, the cover is removed from the housing, the fastening member is unfastened from the opening of the housing, and the electrical disconnection between the device side terminal and the electric wire side terminal is completed.

### SUMMARY OF THE INVENTION

Incidentally, when the fastening member is fastened or the fastening member is unfastened in the connector disclosed in JP 2016-213048 A, the cover is removed from the housing after the interlock terminal and the connecting portion are electrically disconnected. Therefore, if the interlock terminal and the connecting portion are not electrically disconnected, the first conductive member and the second conductive member are in a conduction state even if the cover is removed from the housing. If the fastening member is fastened or unfastened, while the first conductive member and the second conductive member are in a conduction state, electric shock may be caused. Therefore, it is essential to confirm whether the electrical disconnection between the interlock terminal and the connecting portion is performed, and this deteriorates assemblability.

The present disclosure has been devised in view of this kind of problem in the past. An object of the present disclosure is to provide a connector which can enhance assemblability.

A connector according to the present embodiment includes: a housing; a first conductive member housed in the housing; a second conductive member that is housed in the housing and is electrically connected to the first conductive member by fastening a fastening member; a cover that is assembled so as to close an opening of the housing where the fastening member is exposed; and an interlock terminal that is housed in the housing and is connectable and disconnectable a conduction state between the first conductive member and the second conductive member, in which the cover includes a connecting portion that is electrically connected to the interlock terminal and causes the first conductive member and the second conductive member to be in a conduction state, when the cover is assembled to the housing.

According to the present disclosure, it is possible to provide a connector which can enhance assemblability.

### BRIEF DESCRIPTION OF DRAWINGS

FIG. 1 is a perspective view of a connector according to the present embodiment.

FIG. 2 is a cross-sectional view when a cover of the connector according to the present embodiment is arranged at an opening position.

FIG. 3 is a cross-sectional view when the cover of the connector according to the present embodiment is arranged at a standby position.

FIG. 4 is a cross-sectional view when the cover of the connector according to the present embodiment is arranged at an assembly position.

FIG. 5 is a cross-sectional view when the cover of the connector according to the present embodiment is arranged at the opening position.

FIG. 6 is a cross-sectional view when the cover of the connector according to the present embodiment is arranged at the standby position.

FIG. 7 is a cross-sectional view when the cover of the connector according to the present embodiment is arranged at the assembly position.

FIG. 8 is a side view when the cover of the connector according to the present embodiment is arranged at the opening position.

FIG. 9 is a side view when the cover of the connector according to the present embodiment is arranged at the standby position.

FIG. 10 is a side view when the cover of the connector according to the present embodiment is arranged at the assembly position.

FIG. 11 is a perspective view of a housing of the connector according to the present embodiment.

FIG. 12 is a side view of the housing of the connector according to the present embodiment.

FIG. 13 is a bottom view of the housing of the connector according to the present embodiment.

FIG. 14 is a perspective view of the cover of the connector according to the present embodiment.

FIG. 15 is a cross-sectional view of the cover of the connector according to the present embodiment.

### DETAILED DESCRIPTION OF THE INVENTION

A connector according to the present embodiment will be described in detail below with reference to the drawings. The dimensional ratios of the drawings are exaggerated for convenience of explanation and may differ from the actual ratio.

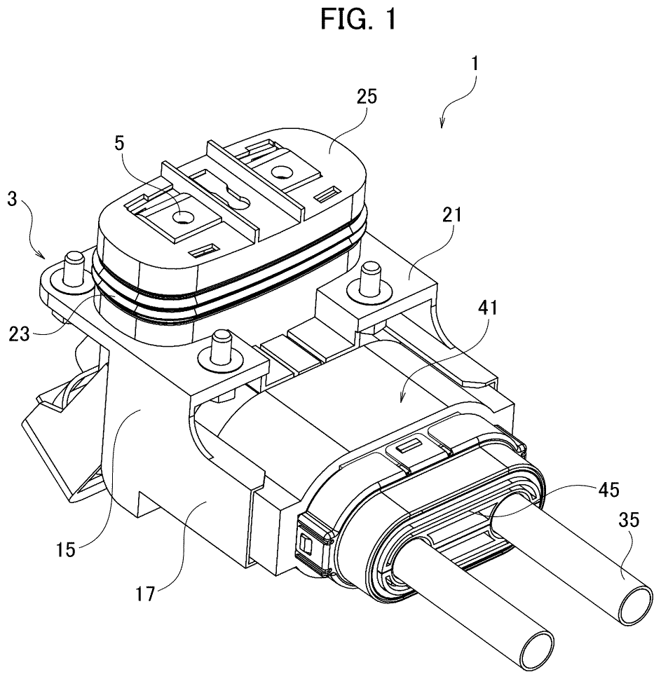

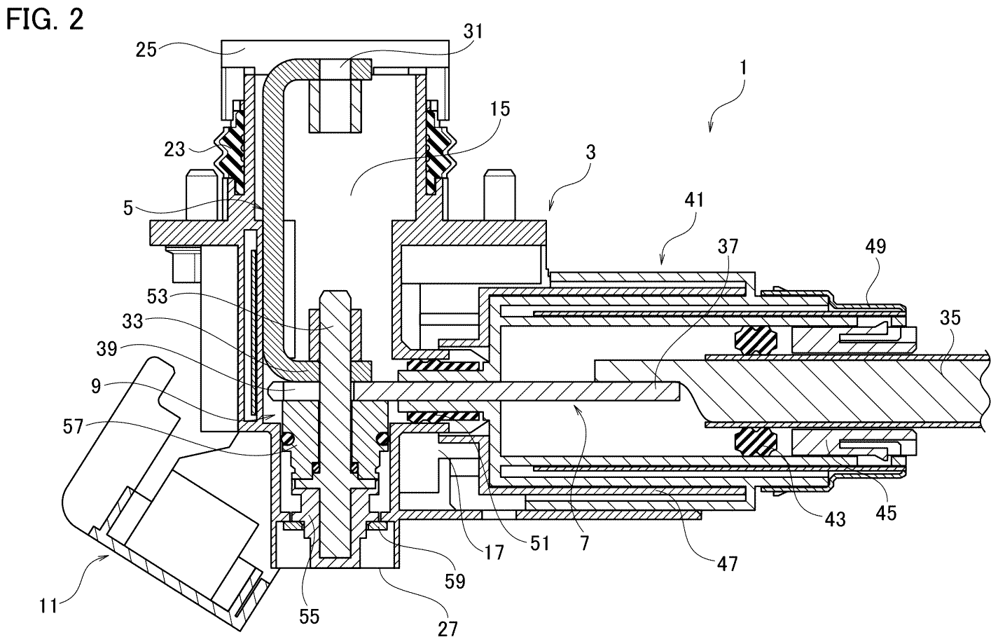

As illustrated in FIG. 1, a connector 1 according to the present embodiment is disposed in one of two electrical components (not illustrated), such as a power source and a device, or a device and a device, for example. The connector 1 has a housing 3 arranged in a first electrical component of the two electrical components. The housing 3 houses a first conductive member 5 (see FIG. 2) electrically connected to the first electrical component, and a second conductive member 7 (see FIG. 2) electrically connected to a second electrical component of the two electrical components. By electrically connecting the first conductive member 5 and the second conductive member 7, the two electrical components are electrically connected.

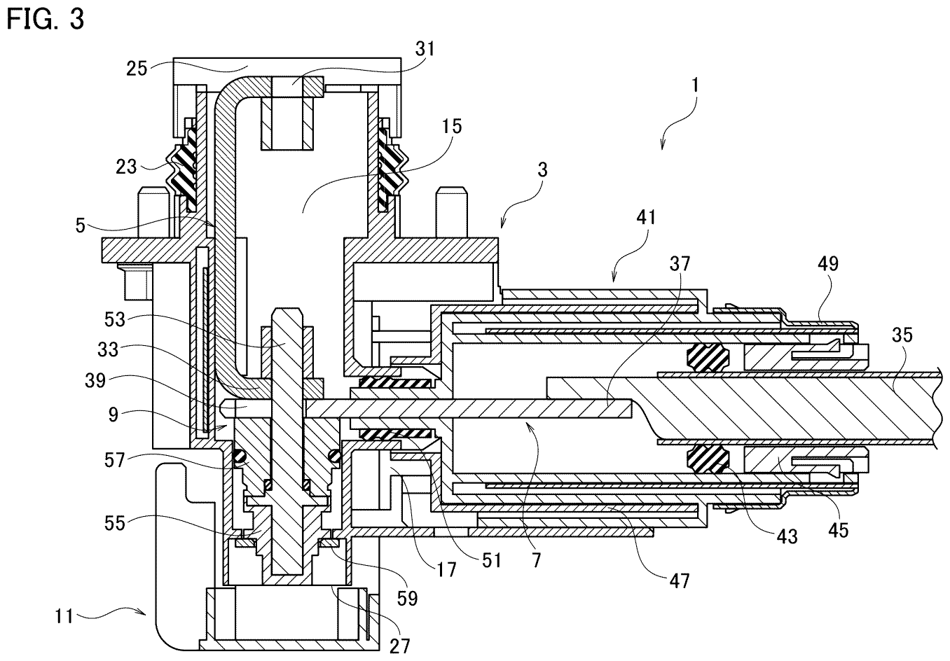

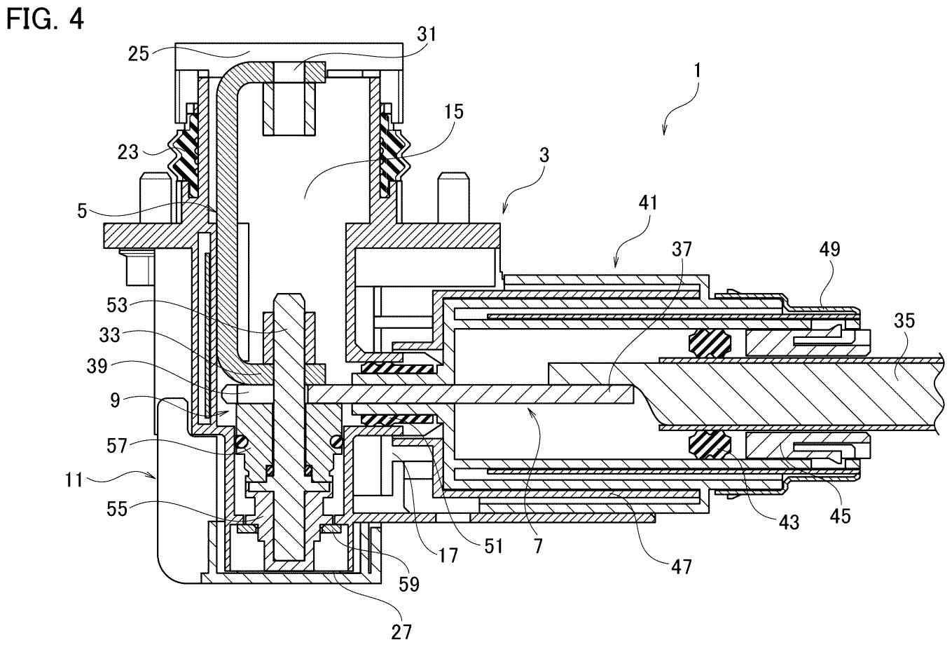

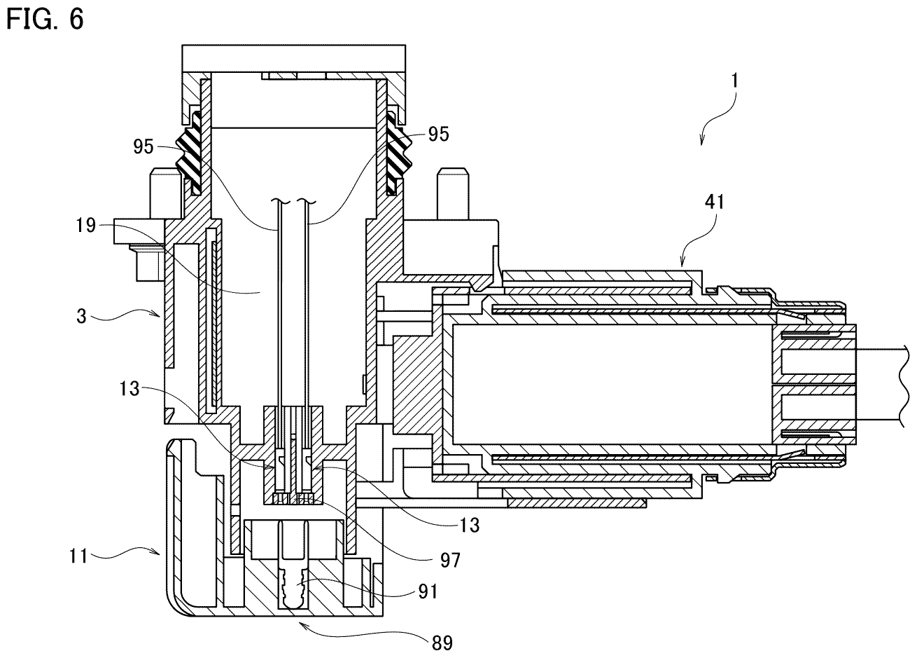

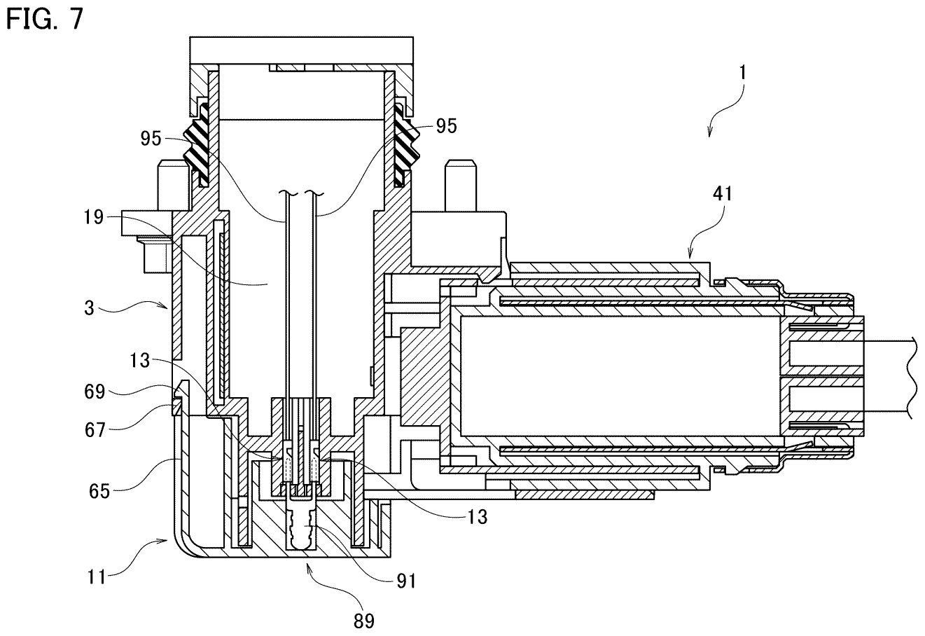

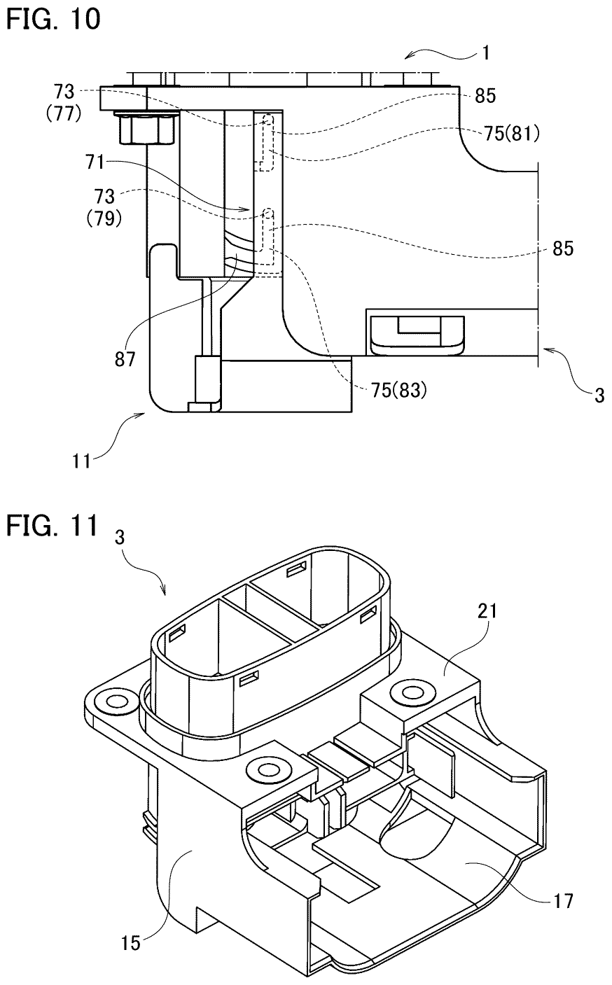

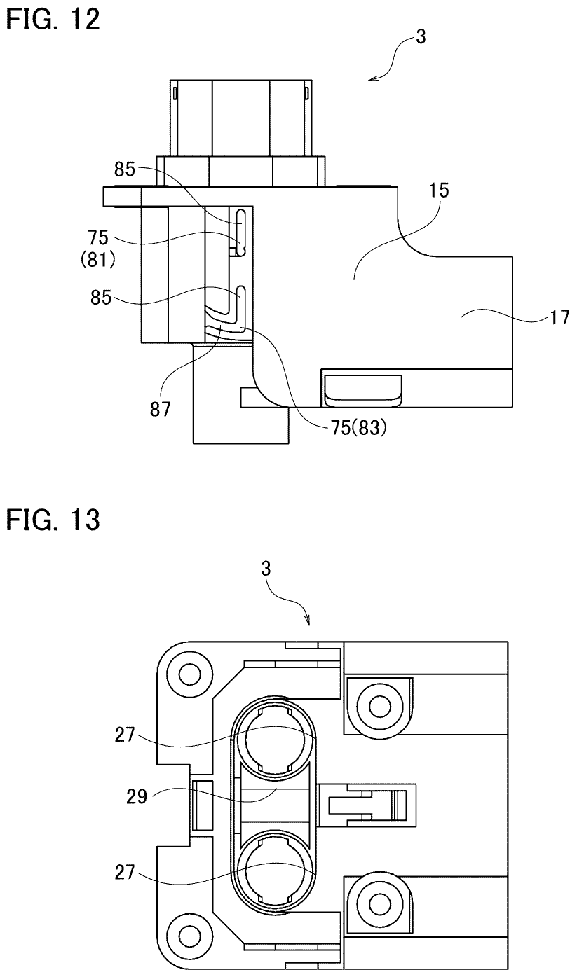

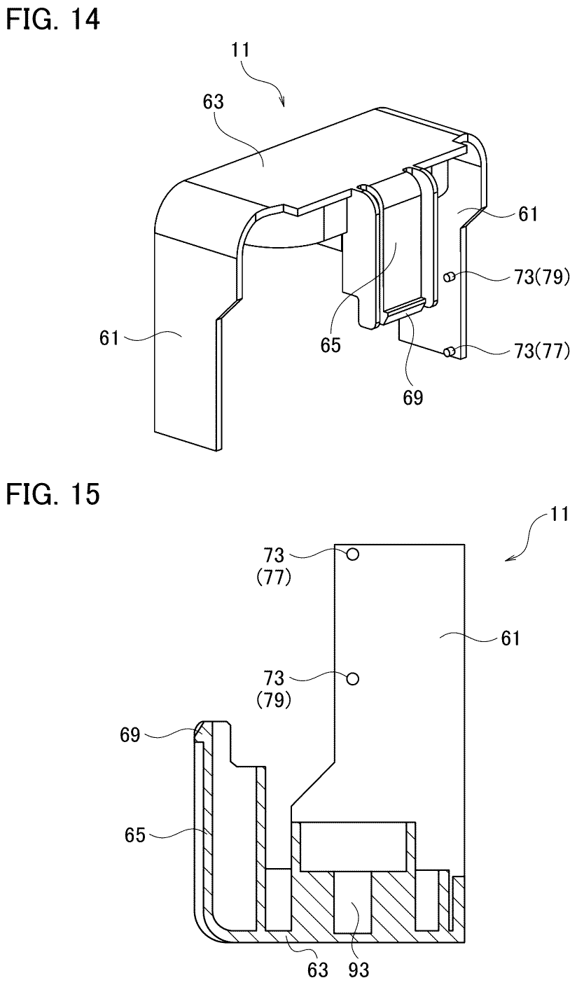

As illustrated in FIGS. 1 to 15, the connector 1 includes the housing 3, the first conductive member 5, the second conductive member 7, a fastening member 9, a cover 11, and interlock terminals 13.

As illustrated in FIGS. 1 to 13, the housing 3 is made of a conductive material such as a metal material, for example. The housing 3 may be made of an insulating material such as a synthetic resin, for example. The housing 3 is formed into an L-shaped housing so as to be able to house the first conductive member 5, the second conductive member 7, and the interlock terminals 13 therein. The housing 3 has a plurality of first housing portions 15 (in this case, two housing portions) which house the first conductive member 5 therein, and a second housing portion 17 which houses the second conductive member 7 therein. The first housing portions 15 and the second housing portion 17 are cylindrically extended in directions perpendicular to each other, and are communicated inside the connector. An interlock terminal accommodator 19 which accommodates the interlock terminals 13 therein is disposed between the adjacent first housing portions 15 and 15. The interlock terminal accommodator 19 is cylindrically extended in a direction parallel to the first housing portions 15. A plurality of fixers 21 fixed to the first electrical component via a plurality of bolts are disposed to the outside of the housing 3. A first seal member 23 which is in close contact with the first electrical component and which seals between the housing 3 and the first electrical component is arranged on the outer periphery of one end side of the first housing portion 15. An arrangement position of the first seal member 23 relative to the housing 3 is held by a seal holder 25 which is assembled so as to close an opening of the first housing portion 15. The seal holder 25 has an opening for exposing the first conductive member 5 and an opening for pulling out an electric wire 95 electrically connected to the interlock terminals 13 to the outside of the housing 3. On the other end side of the first housing portion 15, a plurality of openings 27 (in this case, two openings) through which the fastening member 9 for electrically connecting the first conductive member 5 and the second conductive member 7 is inserted are disposed. A connection opening 29 in which the interlock terminals 13 are arranged is disposed between the adjacent openings 27 and 27.

As illustrated in FIGS. 2 to 4, the first conductive member 5 is made of a conductive material such as a metal material, and is formed into a plate shape such as a bus bar, for example. A plurality of first conductive members 5 (in this case, two first conductive members 5) are used. Both ends of each first conductive member 5 are bent in the same direction to form a U-shape. One end side of each first conductive member 5 serves as a component connecting portion 31 electrically connected to the first electrical component. The component connecting portion 31 is disposed so as to be exposed to the outside of the housing 3 from the opening of the seal holder 25, while each first conductive member 5 is housed in the first housing portion 15 of the housing 3. A through hole is formed in the component connecting portion 31, and a nut is fixed at a position corresponding to the through hole on an inner side of the housing 3. The component connecting portion 31 electrically connects each first conductive member 5 to the first electrical component due to a fastening member (not illustrated) being inserted through the through hole and being fastened to the nut, while a conductive member (not illustrated) on the first electrical component side is disposed. The other end side of each first conductive member 5 serves as a first connecting portion 33 electrically connected to the second conductive member 7. A through hole is formed in the first connecting portion 33, and a nut is fixed at a position corresponding to the through hole on an inner side of the housing 3. The first connecting portion 33 is disposed at a position corresponding to the opening 27 of the first housing portion 15 inside the housing 3, while each first conductive member 5 is housed in the first housing portion 15 of the housing 3.

As illustrated in FIGS. 2 to 4, each second conductive member 7 is made of a conductive material such as a metal material, and is formed into a plate shape such as a bus bar, for example. A plurality of second conductive members 7 (in this case, two second conductive members) are used in correspondence with the first conductive members 5. Each second conductive member 7 is linearly formed by extending in a direction perpendicular to a linear portion of each first conductive member 5. One end side of each second conductive member 7 serves as an electric wire connecting portion 37 electrically connected to a terminal of the electric wire 35. The electric wire 35 is electrically connected to the second electrical component. The electric wire connecting portion 37 is joined to the terminal of the electric wire 35 by means of crimping or the like, and electrically connects each second conductive member 7 and the electric wire 35. The other end side of each second conductive member 7 severs as a second connecting portion 39 electrically connected to the first connecting portion 33 of each first conductive member 5. A through hole is formed in the second connecting portion 39. While each second conductive member 7 is housed in the second housing portion 17 of the housing 3, the second connecting portion 39 is superposed on the first connecting portion 33 of each first conductive member 5 disposed in the first housing portion 15 in the housing 3, and is disposed at a position corresponding to the opening 27. In the present embodiment, each second conductive member 7 electrically connected to the electric wire 35 is housed in a fitting housing 41 which can be fitted with the second housing portion 17 of the housing 3.

As illustrated in FIGS. 1 to 7, the fitting housing 41 is made of an insulating material such as a synthetic resin, for example. The fitting housing 41 can house the electric wire connecting portion 37 of the second conductive member 7 and the terminal of the electric wire 35, and is formed into a housing shape that can be fitted with the second housing portion 17 of the housing 3. On the outer periphery of the electric wire 35 located inside the fitting housing 41, an electric wire seal member 43 which is in close contact with to the fitting housing 41 and seals between the electric wire 35 and the fitting housing 41 is disposed. An arrangement position of the electric wire seal member 43 relative to the fitting housing 41 is held by an electric wire seal holder 45 which is assembled so as to close an opening of the fitting housing 41 on the pulling out side of the electric wire 35. A housing shield member 47 which is electrically connected to the housing 3 when fitted with the housing 3 and forms a shield circuit is mounted on the outer periphery of the fitting housing 41 on the housing 3 side. An electric wire shield member 49 which is electrically connected to a shield member (not illustrated) covering the outer periphery of the electric wire 35 pulled out from the fitting housing 41 and forms the shield circuit is mounted on the outer periphery of the fitting housing 41 on the electric wire 35 side. By forming the shield circuit with the housing shield member 47 and the electric wire shield member 49, intrusion of noise or the like into the connector 1 and leakage of noise or the like from the connector 1 can be prevented. When the fitting housing 41 houses the second conductive member 7, the second connecting portion 39 of the second conductive member 7 is exposed toward the housing 3 side. A second seal member 51 which is in close contact with the housing 3 and seals between the housing 3 and the fitting housing 41 is arranged on the outer periphery of the fitting housing 41 where the second connecting portion 39 is exposed. The second connecting portion 39 of the second conductive member 7 exposed from the fitting housing 41 is electrically connected to the first connecting portion 33 of the first conductive member 5 due to the fastening member 9 inserted through the openings 27 of the housing 3 being fastened.

As illustrated in FIGS. 2 to 4, a plurality of fastening members 9 (in this case, two fastening members 9) are used in correspondence with the plurality of first conductive members 5 (in this case, two first conductive members 5) and the plurality of second conductive members 7 (in this case, two second conductive members 7). Each fastening member 9 includes a fastening portion 53, a resin portion 55, a collar 57, and a locking portion 59.

The fastening portion 53 is made of a metal material, for example. The fastening portion 53 is formed in a shaft shape extending along an extension direction of the first housing portions 15. The outer periphery of the fastening portion 53 is formed in a screw shape so as to be able to be fastened to a nut fixed to the first connecting portion 33.

The resin portion 55 is made of an insulating material such as a synthetic resin, and is disposed on one end side of the fastening portion 53, for example. An inner surface of the resin portion 55 is formed in a screw shape such that the inner surface can be fastened to the fastening portion 53. The resin portion 55 may be integrally insert molded with the fastening portion 53 such that the fastening portion 53 is positioned therein. An outer surface of the resin portion 55 is formed into a polygonal shape such as a hexagonal shape which can be fastened by a jig or the like.

The collar 57 is made of an insulating material such as a synthetic resin, and is arranged more toward the second connecting portion 39 than the resin portion 55 of the fastening portion 53, for example. The collar 57 is annularly formed such that the fastening portion 53 is inserted therethrough and arranged. An O-ring as a seal member for sealing between the fastening portion 53 and the collar 57 is arranged inside the collar 57. An O-ring as a seal member that is in close contact with the housing 3 and seals between the housing 3 and the collar 57 is arranged on the outer periphery of the collar 57.

The locking portion 59 is made of an insulating material such as a synthetic resin, and is arranged over the resin portion 55 and the collar 57 in the periphery of the fastening portion 53, for example. In the locking portion 59, an annular portion formed annularly is engaged with the outer periphery of the resin portion 55, and a plurality of elastic pieces extended from the annular portion toward the collar 57 are engaged with an outer surface of the collar 57. By engaging the locking portion 59 with the resin portion 55 and the collar 57, the fastening members 9 can be handled as one member.

Each fastening member 9 is inserted into the housing 3 through the openings 27 of the housing 3 and is inserted through the through holes in the first connecting portion 33 and the second connecting portion 39, and the fastening portion 53 thereof is arranged at a nut. By rotating the resin portion 55 with a jig or the like, while the fastening portion 53 is arranged at the nut, the fastening portion 53 is fastened to the nut. By fastening the fastening portion 53 to the nut, the first connecting portion 33 and the second connecting portion 39 are brought into contact, each first conductive member 5 and each second conductive member 7 are electrically connected, and the two electrical components are electrically connected. Meanwhile, by rotating the resin portion 55 in an opposite direction with a jig or the like, the fastening portion 53 of the fastening member 9 is unfastened from the nut. The fastening member 9 having the fastening portion 53 which is unfastened from the nut is pulled out from the openings 27 to the outside of the housing 3, and accordingly the fitting housing 41 can be separated from the housing 3. By unfitting the housing 3 and the fitting housing 41, the first conductive member 5 and the second conductive member 7 are electrically disconnected, and the two electrical components are electrically disconnected.

As illustrated in FIGS. 1 to 10, 14, and 15, the cover 11 is made of an insulating material such as a synthetic resin, for example. The cover 11 has a pair of sidewalls 61 and 61 and a coupling wall 63 for coupling the pair of sidewalls 61 and 61, and is formed in a U-shape. The pair of sidewalls 61 and 61 are arranged on both sides of an outer surface of the housing 3, respectively, when the cover 11 is assembled to the housing 3. The coupling wall 63 is formed in a shape capable of closing the openings 27 of the housing 3, and is arranged so as to close the openings 27, when the cover 11 is assembled to the housing 3. Therefore, when the cover 11 is assembled to the housing 3, the first connecting portion 33, the second connecting portion 39, and the fastening member 9 are not exposed to the outside from the openings 27. The cover 11 has an elastically deformable locking piece 65 which extends in a direction parallel to the sidewalls 61 from the coupling wall 63. On a free end side of the locking piece 65, a locking projection 69 is disposed which can engage with a locked portion 67 disposed in the housing 3. By engaging the locking projection 69 of the locking piece 65 with the locked portion 67, a state in which the cover 11 is assembled to the housing 3 can be maintained.

The cover 11 is integrally disposed with the housing 3 via an engaging portion 71 disposed between the cover 11 and the housing 3. By integrally disposing the cover 11 with the housing 3, the housing 3 and the cover 11 can be handled as one member, and the number of parts can be reduced. The engaging portion 71 has pins 73 disposed in the cover 11 and guide grooves 75 disposed in the housing 3.

The pins 73 project inwardly from inner surfaces of the pair of sidewalls 61 and 61 of the cover 11. The pins 73 have a first pin 77 and a second pin 79. The first pin 77 is arranged on a distal end side of the sidewalls 61. The second pin 79 is arranged more toward the coupling wall 63 than the first pin 77 in the sidewalls 61.

The guide grooves 75 are disposed on both sides of the outer surface of the housing 3 where the sidewalls 61 and 61 of the cover 11 are arranged, respectively. The guide grooves 75 have a first guide groove 81 in which the first pin 77 is inserted and engaged and which guides the movement of the first pin 77, and a second guide groove 83 in which the second pin 79 is inserted and engaged and which guides the movement of the second pin 79. The first guide groove 81 is linearly formed parallel to an extension direction of the first housing portion 15. The first guide groove 81 has only an advancing and retreating portion 85 which allows the first pin 77 to move linearly along the first guide groove 81, while the first guide groove 81 is engaged with the first pin 77, and allows the cover 11 to advance and retreat relative to the openings 27 of the housing 3. The first pin 77 engaged with the first guide groove 81 serves as a fulcrum for turning the cover 11 relative to the housing 3. The second guide groove 83 has an opening and closing portion 87 formed in an arc shape along a turning locus of the cover 11, and an advancing and retreating portion 85 which communicates with the opening and closing portion 87 and is linearly formed parallel to the first guide groove 81. The opening and closing portion 87 of the second guide groove 83 allows the second pin 79 to move in an arc shape along the opening and closing portion 87, while the second guide groove 83 is engaged with the second pin 79, and allows the cover 11 to turn relative to the housing 3. The advancing and retreating portion 85 of the second guide groove 83 allows the second pin 79 to move linearly along the advancing and retreating portion 85, while the second guide groove 83 is engaged with the second pin 79, and allows the cover 11 to advance and retract relative to the openings 27 of the housing 3.

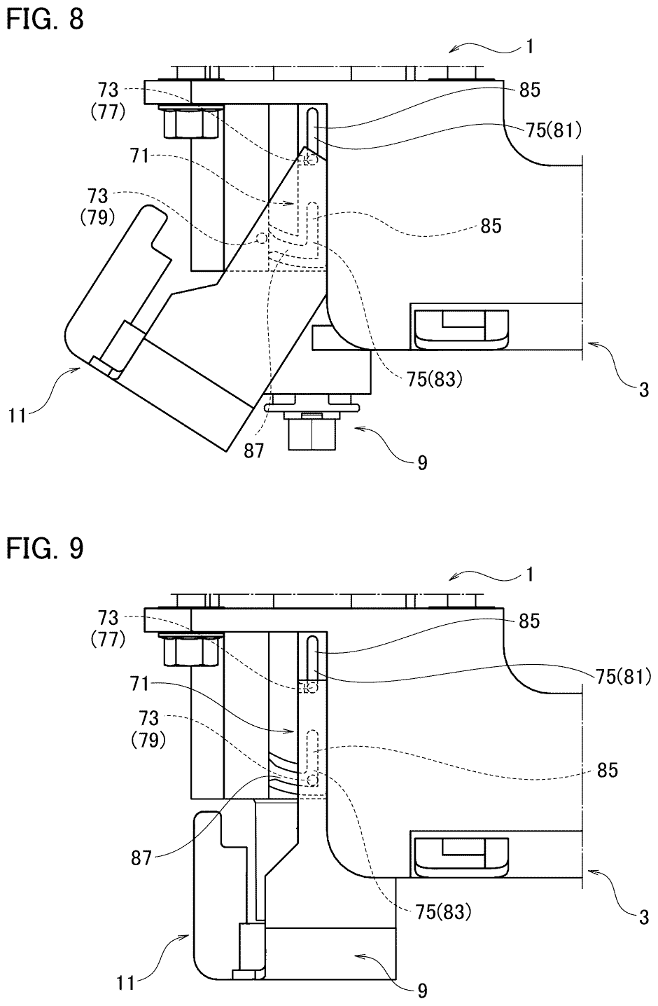

When the second pin 79 is positioned at an opening of the opening and closing portion 87 of the second guide groove 83 of the engaging portion 71, the first pin 77 is positioned at an end of the first guide groove 81 closer to the second guide groove 83. At this time, the cover 11 is arranged at an opening position (see FIG. 8) where the openings 27 of the housing 3 are opened. Using the first pin 77 as a fulcrum, the cover 11 is turned such that the second pin 79 is moved toward the advancing and retreating portion 85 along the opening and closing portion 87 of the second guide groove 83. Accordingly, the second pin 79 abuts a communication portion between the opening and closing portion 87 of the second guide groove 83 and the advancing and retreating portion 85. At this time, the cover 11 is arranged at a standby position (see FIG. 9) which is separated from the openings 27 of the housing 3 and which faces the openings 27. The cover 11 is moved toward the openings 27 such that the first pin 77 moves along the first guide groove 81 (advancing and retreating portion 85) and the second pin 79 moves along the advancing and retreating portion 85 of the second guide groove 83. Accordingly, the first pin 77 abuts an end of the first guide groove 81 and the second pin 79 abuts an end of the advancing and retreating portion 85. At this time, the cover 11 is arranged at an assembly position (see FIG. 10) for closing the openings 27 of the housing 3. At the assembly position of the cover 11, the locking projection 69 of the locking piece 65 is engaged with the locked portion 67 of the housing 3, and an assembly state of the cover 11 relative to the housing 3 is maintained.

The coupling wall 63 of the cover 11 has a connecting portion 89. The connecting portion 89 has a short terminal 91 made of a conductive material. The short terminal 91 is housed and fixed in a short housing portion 93 disposed on the coupling wall 63 by means of press-fitting or the like. The short terminal 91 of the connecting portion 89 is electrically connected to the interlock terminals 13 when the cover 11 is assembled to the housing 3.

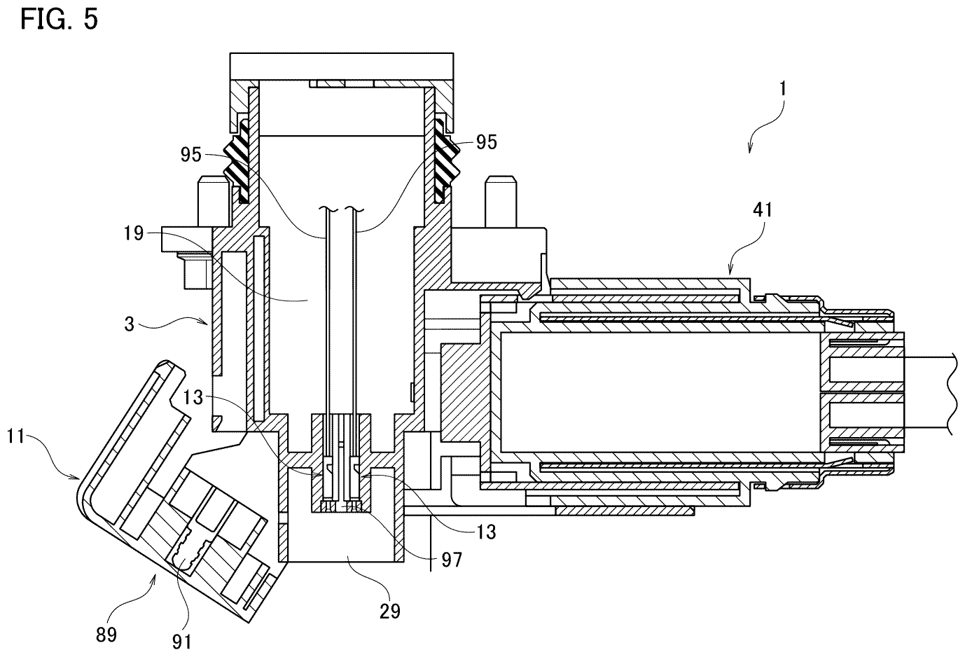

As illustrated in FIGS. 5 to 7, the interlock terminals 13 are made of conductive materials, and are formed of a female terminal with a box-shaped connecting portion into which the short terminal 91 can be inserted, for example. A pair of interlock terminals 13 are used. The pair of interlock terminals 13 are electrically connected to terminals of the pair of electric wires 95, respectively. The pair of electric wires 95 are electrically connected to an interlock circuit (not illustrated) which controls a conduction state between the first conductive member 5 disposed at the first electrical component and the second conductive member 7. The interlock terminals 13 are arranged at the position corresponding to the connection opening 29 in a state where the interlock terminals 13 are accommodated in the interlock terminal accommodator 19 of the housing 3. An inter-holder 97 having an opening through which the short terminal 91 can be inserted is assembled to the connection opening 29, and the arrangement position of the interlock terminals 13 relative to the housing 3 is held. When the cover 11 is assembled to the housing 3, the pair of interlock terminals 13 are electrically connected to the short terminal 91 of the connecting portion 89, and cause the first conductive member 5 and the second conductive member 7 to be in a conduction state. Meanwhile, when the cover 11 is removed from the housing 3, the pair of interlock terminals 13 are electrically disconnected from the short terminal 91 of the connecting portion 89, and the first conductive member 5 and the second conductive member 7 are in a non-conduction state.

By disposing the connecting portion 89 electrically connected to the interlock terminals 13 in the cover 11, each first conductive member 5 and each second conductive member 7 are in a non-conduction state, when the cover 11 is not assembled to the housing 3. Therefore, even if each fastening member 9 is fastened or each fastening member 9 is unfastened in the openings 27 of the housing 3, electric shock is not caused, and assemblability can be enhanced. In addition, the cover 11 is not able to approach the opening 27, when the pin 73 is positioned at the opening and closing portion 87 of the guide groove 75 in the engaging portion 71. Therefore, when the cover 11 opens the opening 27, the cover 11 is not assembled to the housing 3, and the interlock terminal 13 and the connecting portion 89 are not electrically connected.

When fastening each fastening member 9 in the connector 1, each fastening member 9 is inserted through the opening 27 and fastened, while the cover 11 is arranged at an opening position relative to the housing 3. At this time, since the interlock terminals 13 and the connecting portion 89 are not electrically connected, each first conductive member 5 and each second conductive member 7 are in a non-conduction state, and electric shock is not caused. After fastening each fastening member 9, by turning the cover 11 to a standby position and moving the cover 11 to an assembly position, the interlock terminals 13 and the connecting portion 89 are electrically connected, and each first conductive member 5 and each second conductive member 7 can be brought into a conduction state.

Meanwhile, when unfastening each fastening member 9 in the connector 1, the cover 11 is moved to the standby position and the cover 11 is turned to the opening position. In a state where the cover 11 is moved to the standby position, the interlock terminals 13 and the connecting portion 89 are electrically disconnected, and therefore each first conductive member 5 and each second conductive member 7 are in a non-conduction state. Therefore, even if the opening 27 is exposed when the cover 11 is turned to the opening position, electric shock is not caused. By unfastening each fastening member 9 from the opening 27, each fastening member 9 can be easily pulled out from the opening 27.

This kind of connector 1 includes the housing 3, each first conductive member 5 housed in the housing 3, and each second conductive member 7 which is housed in the housing 3 and is electrically connected to each first conductive member 5 by fastening each fastening member 9. In addition, the connector 1 includes the cover 11 which is assembled so as to close the opening 27 of the housing 3 where each fastening member 9 is exposed, and the interlock terminals 13 which are housed in the housing 3 and which can connect and disconnect a conduction state between each first conductive member 5 and each second conductive member 7. The cover 11 has the connecting portion 89 which is electrically connected to the interlock terminals 13 and causes each first conductive member 5 and each second conductive member 7 to be in a conduction state when the cover 11 is assembled to the housing 3.

When the cover 11 is not assembled to the housing 3, the interlock terminals 13 and the connecting portion 89 are not electrically connected, and each first conductive member 5 and each second conductive member 7 are in a non-conduction state. Therefore, even if each fastening member 9 is fastened or each fastening member 9 is unfasted in the opening 27 of the housing 3, electric shock is not caused, and assemblability can be enhanced.

Therefore, in this kind of connector 1, it is not necessary to confirm a conduction state of each first conductive member 5 and each second conductive member 7 when each fastening member 9 is fastened or each fastening member 9 is unfastened, and assemblability can be enhanced.

Further, the cover 11 is integrally assembled with the housing 3 via the engaging portion 71.

Therefore, the housing 3 and the cover 11 can be handled as one member, and the number of parts can be reduced.

Further, the engaging portion 71 has the pin 73 disposed in one of the housing 3 and the cover 11, and the guide groove 75 in which the pin 73 is inserted, which is disposed in the other of the housing 3 and the cover 11, and which guides the movement of the pin 73. The guide groove 75 has the opening and closing portion 87 which enables the cover 11 to be opened and closed relative to the opening 27, and the advancing and retreating portion 85 which enables the cover 11 to be advanced and retreated relative to the opening 27.

The cover 11 is not able to approach the opening 27, when the pin 73 is positioned at the opening and closing portion 87 of the guide groove 75 in the engaging portion 71. Therefore, when the cover 11 opens the opening 27, the cover 11 is not assembled to the housing 3, and the interlock terminal 13 and the connecting portion 89 are not electrically connected.

Although the present embodiment has been described above, the present embodiment is not limited to the above description, and various modifications can be made within the scope of the gist of the present embodiment.

Although the number of each of the first conductive member and the second conductive member is two (two sets), the number is not limited thereto, and the number of each of the first conductive member and the second conductive member may be one (one set) or three (three sets) or more, for example.

Further, each second conductive member is housed in the fitting housing which can be fitted with the housing, but the present embodiment is not limited thereto, and each second conductive member may be housed directly in the housing.

Further, the pin is disposed in the cover, and the guide groove is disposed in the housing, but the present embodiment is not limited thereto, and alternatively the pin may be disposed in the housing, and the guide groove may be disposed in the cover.

Moreover, temporary holding portion may be disposed between the housing and the cover, which are engaged with each other at the opening position of the cover and the standby position of the cover to hold the arrangement position of the cover and are disengaged when the cover moves.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a housing;
a first conductive member housed in the housing;
a second conductive member that is housed in the housing and is electrically connected to the first conductive member by fastening a fastening member;
a cover that is assembled so as to close an opening of the housing where the fastening member is exposed; and
an interlock terminal that is housed in the housing and is connectable and is disconnectable a conduction state between the first conductive member and the second conductive member, wherein
the cover includes a connecting portion that is electrically connected to the interlock terminal and causes the first conductive member and the second conductive member to be in a conduction state, when the cover is assembled to the housing.

2. The connector according to claim 1, wherein
the cover is integrally assembled with the housing via an engaging portion.

3. The connector according to claim 2, wherein
the engaging portion has a pin disposed in one of the housing and the cover, and a guide groove in which the pin is inserted, which is disposed in the other of the housing and the cover, and which guides movement of the pin, and
the guide groove has an opening and closing portion that enables the cover to be opened and closed relative to the opening, and an advancing and retreating portion that enables the cover to be advanced and retreated relative to the opening.
